(19) United States
(12) Patent Application Publication
(10) Pub. No.: US 2024/0265909 A1
(43) Pub. Date: Aug. 8, 2024

(54) TEXT-TO-SPEECH DEVICE, METHOD OF CONTROLLING TEXT-TO-SPEECH DEVICE, AND COMPUTER-READABLE STORAGE MEDIUM

(71) Applicant: JVCKENWOOD Corporation, Yokohama-shi (JP)

(72) Inventors: Daisuke Ogoshi, Yokohama-shi (JP); Hiroshi Takeshita, Yokohama-shi (JP); Yuta Arai, Yokohama-shi (JP); Yuki Momma, Yokohama-shi (JP); Takayuki Kasahara, Yokohama-shi (JP); Reina Takaya, Yokohama-shi (JP)

(21) Appl. No.: 18/433,497

(22) Filed: Feb. 6, 2024

(30) Foreign Application Priority Data
Feb. 7, 2023 (JP) 2023-016802

(51) Int. Cl. G10L 13/04; G01C 21/36; G06V 20/40; G06V 20/62

(52) U.S. Cl. CPC G10L 13/04; G01C 21/3602; G01C 21/3629; G06V 20/40; G06V 20/63

(57) ABSTRACT

A text-to-speech device includes: a video data acquisition unit configured to acquire video data including a video of a region around a user; a positional information acquisition unit configured to acquire positional information indicating a position of a user; a category identification unit configured to identify a category of a location where the user is positioned, based on the acquired positional information and map information related to an area including the position of the user indicated by the positional information; a text extraction unit configured to extract text information representing text included in video data of a region around the user; a priority setting unit configured to set degrees of priority for the extracted text information; and a voice output unit configured to convert the extracted text information into voice, and outputs the voice, in descending order of the set degrees of priority.

### CROSS-REFERENCE TO RELATED APPLICATION

This application claims priority from Japanese Application No. 2023-016802, filed on Feb. 7, 2023, the contents of which are incorporated by reference herein in its entirety.

### BACKGROUND

The present disclosure relates to a text-to-speech device, a method of controlling the text-to-speech device, and a computer-readable storage medium.

Recognizing information represented by characters posted on the street in performing daily activities is difficult for users having impaired vision and this sometimes prevents them from performing daily activities. There has thus been a technique for reading aloud text information by voice from a video captured by a camera and a technique for extracting text from an image or a video and reading aloud the extracted text, for example.

For example, a visual recognition assistance device disclosed in Japanese Unexamined Patent Application Publication No. 2016-194612 appropriately reads aloud information in images and includes a detecting means for detecting an object that is at least one of a character string and a body that are included in a subject image, a name information acquiring means for acquiring a name for the object detected by the detecting means, a speaker for outputting voice to at least a user, and a text-to-speech control means for reading aloud in parallel, in a case where a plurality of objects are detected from one subject image, names acquired by the name information acquiring means respectively for the objects, via the speaker.

However, the visual recognition assistance device described in Japanese Unexamined Patent Application Publication No. 2016-194612 is able to read aloud the names in parallel via the speaker in the case where a plurality of objects have been recognized in the image, but is unable to set, in reading them aloud, degrees of priority for contents of text recognized in the image.

### SUMMARY

A text-to-speech device according to an embodiment includes: a video data acquisition unit configured to acquire video data including a video of a region around a user; a positional information acquisition unit configured to acquire positional information indicating a position of the user; a category identification unit configured to identify a category of a location where the user is positioned, based on the positional information acquired by the positional information acquisition unit and map information related to an area including the position of the user indicated by the positional information; a text extraction unit configured to extract pieces of text information representing pieces of text included in the video data, based on the video data acquired by the video data acquisition unit; a priority setting unit configured to set degrees of priority for the pieces of text information extracted by the text extraction unit; and a voice output unit configured to convert the pieces of text information extracted by the text extraction unit into voice, and outputs the voice, in descending order of the degrees of priority set by the priority setting unit. The higher relevance of the pieces of text information to the category of the location identified by the category identification unit, the higher the degrees of priority set by the priority setting unit for the pieces of text information.

### BRIEF DESCRIPTION OF THE DRAWINGS

FIG. 1 is a schematic diagram illustrating an outline of a text-to-speech device according to the present disclosure;

FIG. 2 is a diagram illustrating a configuration of the text-to-speech device according to the present disclosure;

FIG. 3 is a diagram illustrating an example of pieces of text information extracted by a text extraction unit of the text-to-speech device according to the present disclosure;

FIG. 4 is a diagram illustrating an example of degrees of priority for pieces of text information set by a priority setting unit of the text-to-speech device according to the present disclosure;

FIG. 5 is a flowchart illustrating a flow of a process for when a new piece of text information has been detected in the text-to-speech device according to the present disclosure; and

FIG. 6 is a flowchart illustrating a flow of a process for when a piece of text information has disappeared from video data in the text-to-speech device according to the present disclosure.

### DETAILED DESCRIPTION

Embodiments of the present invention will hereinafter be described in detail, on the basis of the drawings. The present invention is not limited by the embodiments described hereinafter.

### Outline of Text-to-Speech Device

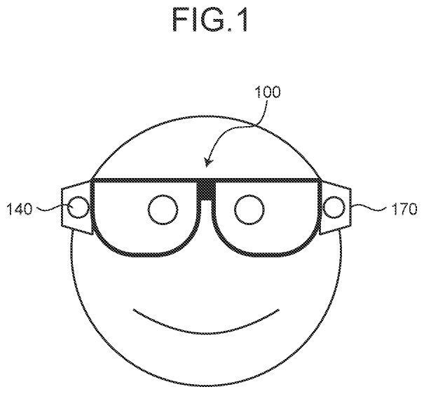

Firstly, an outline of a text-to-speech device 100 according to the present disclosure will be described by use of FIG. 1. FIG. 1 is a schematic diagram illustrating an outline of a text-to-speech device according to the present disclosure. As illustrated in FIG. 1, the text-to-speech device 100 according to the present disclosure may be a device configured to be used by being worn on a user's head, that is, a wearable device. As illustrated in FIG. 1, the text-to-speech device 100 according to the present disclosure includes an imaging unit 140 and a speaker 170. The text-to-speech device 100 also includes other components, which will be described later.

The text-to-speech device 100 according to the present disclosure may be configured in another way not illustrated in FIG. 1, without being limited to the device configured as illustrated in FIG. 1.

The text-to-speech device 100 configured as illustrated in FIG. 1 is, for example, a head-mounted device, extracts pieces of text information in real time from an image captured by the imaging unit 140 described later and reads aloud the extracted pieces of text information by voice. The text-to-speech device 100 reads aloud pieces of text in order of priority by analyzing the image and assigning priority rankings on the basis of information, such as distances to the pieces of text, sizes of the pieces of text, colors of the pieces of text, typefaces of the pieces of text, and light emission patterns of the pieces of text, and the present location. Each piece of text is managed by addition of tags to the piece of text, the tags being information, such as a degree of priority and unnecessity of text-to-speech reading, and efficient visual assistance is thereby implemented for users. The text-to-speech device 100 according to the embodiment is able to be used by, not only a user having impaired vision, but also a user not having impaired vision.

### Configuration of Text-to-Speech Device

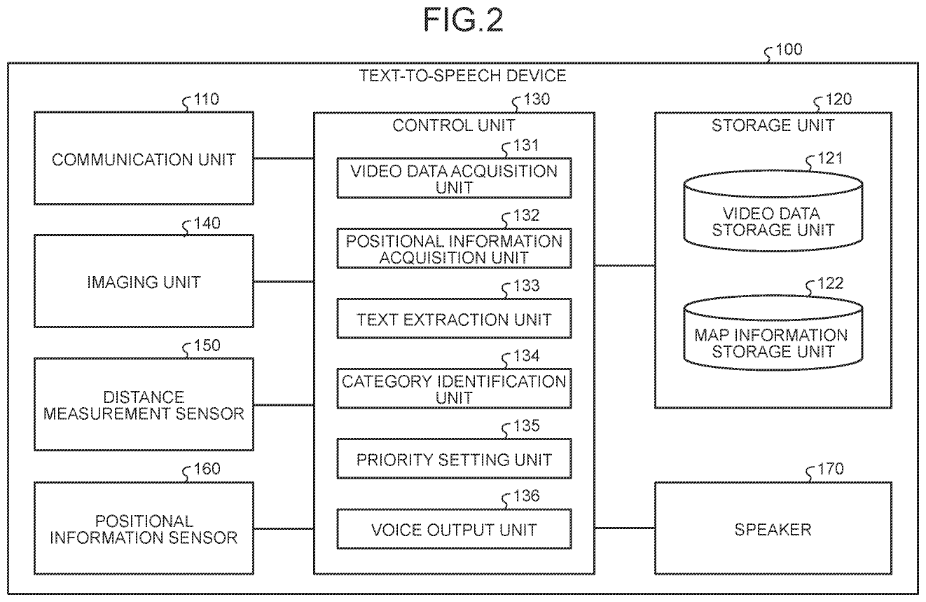

A configuration of the text-to-speech device 100 according to the present disclosure will be described next by use of FIG. 2. FIG. 2 is a diagram illustrating a configuration of the text-to-speech device according to the present disclosure. As illustrated in FIG. 2, the text-to-speech device 100 according to the present disclosure includes a communication unit 110, a storage unit 120, a control unit 130, the imaging unit 140, a distance measurement sensor 150, a positional information sensor 160, and the speaker 170. These components will hereinafter be described in sequence.

The communication unit 110 transmits and receives information between the text-to-speech device 100 and another device. For example, the communication unit 110 may be implemented by a wireless local area network (LAN) card, a Bluetooth (registered trademark) module, a Wi-Fi (registered trademark) module, and/or an antenna.

The storage unit 120 is a storage device to store various types of information. The storage unit 120 may be implemented by a main storage device and an auxiliary storage device. The main storage device may be implemented by, for example, a semiconductor memory element, such as a random access memory (RAM), a read only memory (ROM), or a flash memory. The auxiliary storage device may be implemented by, for example, a hard disk, a solid state drive (SSD), or an optical disk.

As illustrated in FIG. 2, the storage unit 120 includes a video data storage unit 121 and a map information storage unit 122.

The video data storage unit 121 stores video data captured by the imaging unit 140. The video data storage unit 121 may store sets of video data captured by the imaging unit 140 by assigning identifiers to the sets of video data to enable the individual sets of video data to be identified. The video data may have any data format, which may be, for example, MPEG-4.

The map information storage unit 122 stores map information. The map information stored by the map information storage unit 122 includes information related to categories of locations, such as green spaces, rivers, roads, train stations, airports, shops, and event venues, and information on districts, such as prefectures. The map information may be information divided in a predetermined mesh on the basis of latitude and longitude. In this case, the map information has been divided in a predetermined mesh on the basis of latitude and longitude, and a piece of map information on an area including a predetermined position is thus able to be read by specification of a latitude, a longitude, and a dimension in the mesh.

The control unit 130 is a controller that governs and controls the text-to-speech device 100. The control unit 130 is implemented by, for example, various programs being executed by a central processing unit (CPU) or a micro processing unit (MPU), with a RAM being a work area, the various programs having been stored in the storage unit 120. Furthermore, the control unit 130 may be implemented by, for example, an integrated circuit, such as an application specific integrated circuit (ASIC) or a field programmable gate array (FPGA).

As illustrated in FIG. 2, the control unit 130 includes a video data acquisition unit 131, a positional information acquisition unit 132, a text extraction unit 133, a category identification unit 134, a priority setting unit 135, and a voice output unit 136. The control unit 130 reads and executes the programs from the storage unit 120 and thereby implements these components and executes their processing. The control unit 130 may execute the processing by means of one CPU or may include a plurality of CPUs and execute the processing in parallel by means of the plurality of CPUs. The components will hereinafter be described in sequence.

The video data acquisition unit 131 acquires video data including a video of a region around a user. That is, the video data acquisition unit 131 acquires video data including a video of a region around a user, the video having been captured by the imaging unit 140. The video data acquisition unit 131 stores the video data acquired, into the video data storage unit 121 upon acquisition of the video data from the imaging unit 140.

The positional information acquisition unit 132 acquires positional information indicating a position of a user. That is, the positional information acquisition unit 132 acquires, from the positional information sensor 160, which will be described later, positional information measured by the positional information sensor 160. The positional information acquisition unit 132 outputs the positional information acquired, to the category identification unit 134 upon acquisition of the positional information from the positional information sensor 160.

The text extraction unit 133 extracts, on the basis of video data acquired by the video data acquisition unit 131, pieces of text information representing pieces of text included in the video data. Pieces of text herein mean characters, character strings, and/or sentences. The text extraction unit 133 may be implemented by use of, for example, the optical character recognition (OCR) technique. The optical character recognition technique is a technique for transcribing text that appears in an image by using image recognition and converting the text into text data. For example, a model for detecting text included in an image using an image recognition technique and a model for classifying the detected text and recognizing the detected text as text data may be used. These models are implemented by, for example, a neural network. The text extraction unit 133 may execute optical character recognition per frame of the video data acquired by the video data acquisition unit 131 and extract text information included in the video data.

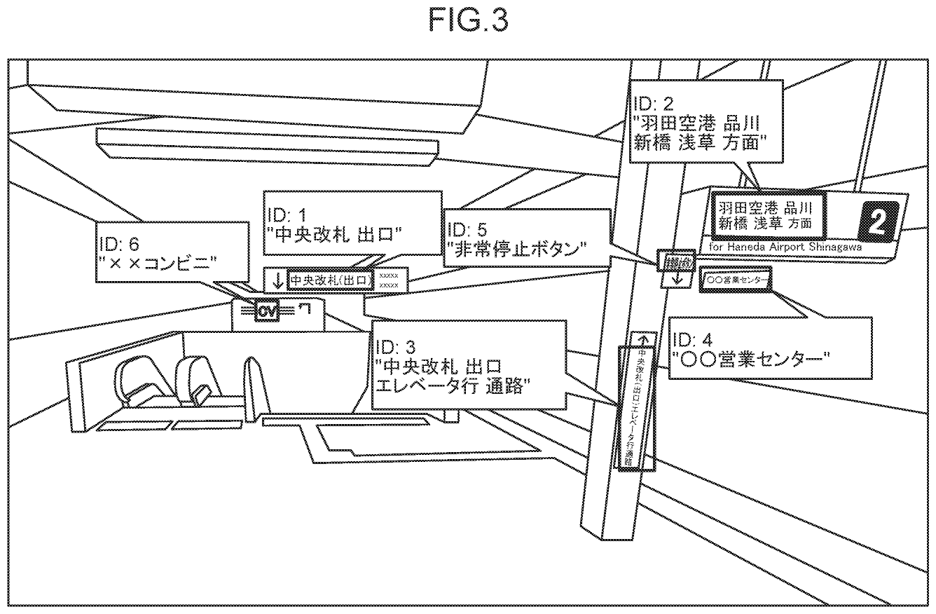

An example of pieces of text information extracted by the text extraction unit 133 will now be described by use of FIG. 3. FIG. 3 is a diagram illustrating an example of pieces of text information extracted by a text extraction unit of the text-to-speech device according to the present disclosure. As illustrated in FIG. 3, the text extraction unit 133 extracts pieces of text that appear in an image, from video data acquired by the video data acquisition unit 131 and extracts the pieces of text as pieces of text information. FIG. 3 illustrates that the pieces of text information have been extracted from the video data, the pieces of text information corresponding to pieces of text, such as Japanese characters [symbol] [symbol] (“Central Ticket Gate Exit” in English), Japanese characters [symbol] [symbol] [symbol] [symbol] [symbol] (“Bound for Haneda Airport, Shinagawa, Shimbashi, and Asakusa” in English), Japanese characters [symbol] [symbol] [symbol] [symbol] (“Passageway to Elevator at Central Ticket Gate Exit” in English), Japanese characters [symbol] (“XYZ Business Center” in English), Japanese characters [symbol] (“Emergency Stop Button” in English), and Japanese characters [symbol] (“ABC Convenience Store” in English). (Note that FIG. 3 illustrates extraction of pieces of text in Japanese characters by way of example.) As illustrated in FIG. 3, the text extraction unit 133 may assign, to each piece of text information extracted, an “ID” that is an identifier to identify the piece of text information.

On the basis of positional information acquired by the positional information acquisition unit 132 and map information related to an area including a position of a user, the position being indicated by the positional information, the category identification unit 134 identifies a category of a location where the user is positioned. Firstly, the category identification unit 134 reads the map information related to the area including the position of the user, the position being indicated by the positional information acquired by the positional information acquisition unit 132, from the map information storage unit 122. The category identification unit 134 then identifies the category indicated by the map information related to the area including the position of the user. Specifically, the category identification unit 134 identifies the category of the location where the user is positioned, by referring to the category included in the map information. The category identification unit 134 may acquire, via the communication unit 110, the map information related to the area including the position of the user indicated by the positional information, from an external server apparatus that provides map information.

The priority setting unit 135 sets degrees of priority for pieces of text information extracted by the text extraction unit 133. That is, the priority setting unit 135 respectively sets degrees of priority for a plurality of pieces of text information extracted by the text extraction unit 133. The degrees of priority are indices serving as the basis for determining the sequence the pieces of text information are to be read aloud in, and the higher the degrees of priority are, the earlier the pieces of text information are read aloud in the sequence. As to the set of the pieces of text information extracted, the priority setting unit 135 sets the same degree of priority for pieces of text information that have been grouped according to specific patterns and rules, scores the degrees of priority according to positions of the pieces of text, their distances from a user, and sizes, colors, and light emission patterns of the pieces of text, and adds the scored degrees of priority to a text-to-speech candidate list.

The higher the relevance of a piece of text information to a category of a location identified by the category identification unit 134, the higher the degree of priority set by the priority setting unit 135 for the piece of text information. The priority setting unit 135 increases or decreases the score of the degree of priority for a piece of text represented by a piece of text information, according to a category of the present location of the user (for example, a station, an airport, a shop, or an event venue). For example, in a case where the user is at a station, a high score is assigned to a piece of text information if the piece of text represented by the piece of text information is information related to a facility of the station or a train (for example, an elevator, a ticket gate, an exit, a ticket vending machine, a destination, or a direction). For pieces of text information related to other categories, pieces of text to be given high scores may be set similarly. For example, in a case where the user is at an airport, a high score may be assigned to a piece of text information if the piece of text represented by the piece of text information is information related to a check-in counter, a baggage checking area, an exchange shop, or a travel agency counter. Furthermore, in a case where the user is in a shop, a high score may be assigned to a piece of text information if the piece of text represented by the piece of text information is information related to the name of the shop. In a case where the user is at an event venue, a high score may be assigned to a piece of text information if the piece of text represented by the piece of text information is information related to the stands or arena.

The closer the position of a piece of text extracted by the text extraction unit 133 to the center in the video data, the larger the size of the piece of text in the video data, and the higher the contrast between the piece of text and the background in the video data, the higher the score set for the degree of priority by the priority setting unit 135 for the piece of text information representing the piece of text. The closer the position of a piece of text of a piece of text information extracted by the text extraction unit 133 to the center, the higher the score set by the priority setting unit 135 for the piece of text information. Furthermore, a distance to each piece of text information in a video is measured by a distance measurement sensor and the nearer the distance to a piece of text information, the higher the score set by the priority setting unit 135 for the piece of text information. Furthermore, the larger the size of a piece of text, the higher the score set by the priority setting unit 135 for the piece of text. The size of the piece of text is calculated by multiplication of the distance to the detected piece of text, the distance having been acquired from the distance measurement sensor 150, by the size of the piece of text in the video. As to the color and typeface of a piece of text, the priority setting unit 135 calculates a contrast between the color of the piece of text and the background, and the higher the contrast calculated, the higher the score assigned by the priority setting unit 135 to the piece of text. Furthermore, as to the light emission pattern, the higher the brightness contrast between the piece of text and the surroundings, the higher the score set by the priority setting unit 135. Furthermore, in a case where the piece of text is flashing, for example, the priority setting unit 135 increases the score. How pieces of text are scored according to these factors may be selected or customized by a user in any way.

The priority setting unit 135 sets degrees of priority for pieces of text information extracted, on the basis of degrees of priority that have been set for respective pieces of text for each user beforehand. That is, information related to degrees of priority of respective pieces of text may be stored beforehand in the storage unit 120, and the priority setting unit 135 may read the information related to the degrees of priority for the respective pieces of text stored in the storage unit 120 and set, on the basis of the degrees of priority for the pieces of text, degrees of priority for pieces of text information extracted. That is, on the basis of scores set respectively for the pieces of text, the scores having been stored beforehand, the degrees of priority are set.

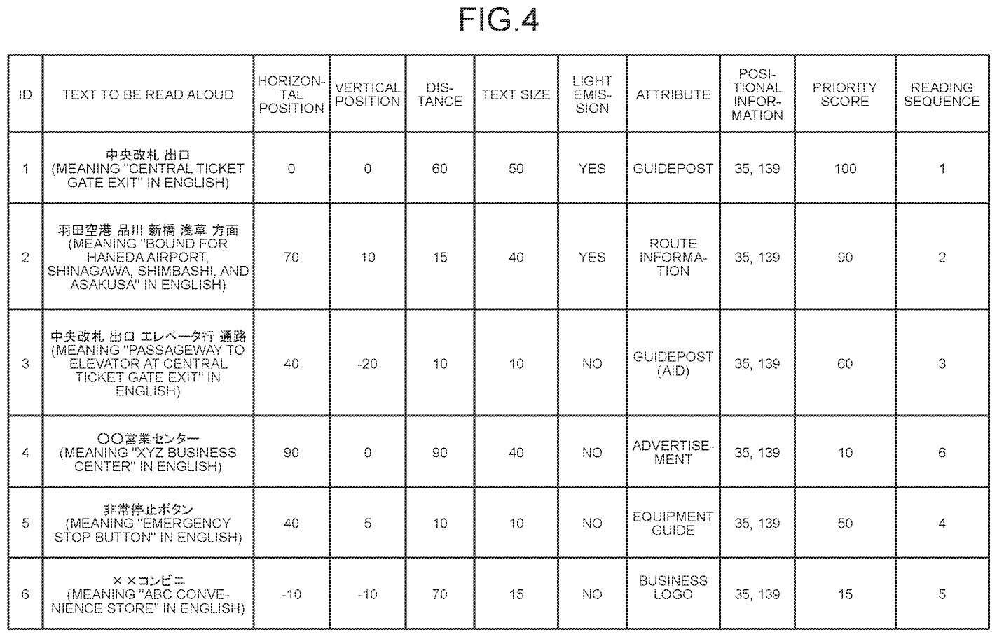

An example of degrees of priority for pieces of text information set by the priority setting unit 135 will now be described by use of FIG. 4. FIG. 4 is a diagram illustrating an example of degrees of priority for pieces of text information set by a priority setting unit of the text-to-speech device according to the present disclosure. The pieces of text information illustrated in FIG. 4 are pieces of text to be read aloud and thus the list illustrated in FIG. 4 may also be called a “text-to-speech list”. FIG. 4 illustrates information related to items, such as “ID”, “text to be read aloud”, “horizontal position”, “vertical position”, “distance”, “text size”, “light emission”, “attribute”, “positional information”, “priority score”, and “reading sequence”.

The item, “ID”, is an identifier to identify the piece of text information and is represented by a number. The item, “text to be read aloud”, indicates the piece of text included in the piece of text information. The item, “horizontal position”, indicates the horizontal position of the piece of text information in the video data. The item, “vertical position”, indicates the vertical position of the piece of text information in the video data. The item, “distance”, indicates the distance to the piece of text information measured by the distance measurement sensor 150. The item, “text size”, indicates the size of the piece of text represented by the piece of text information. The item, “light emission”, indicates whether or not the piece of text information is emitting light. The item, “attribute”, is information related to the attribute of the piece of text information. The item, “positional information”, indicates the position of the user at the time the piece of text information was extracted. The item, “priority score”, indicates the score of the degree of priority for the piece of text information. The item, “reading sequence”, indicates the rank of the piece of text information in the reading sequence, the rank having been determined on the basis of “priority score”.

That is, on the basis of “horizontal position” and “vertical position”, the priority setting unit 135 calculates the distance to the position of the piece of text information in the video data from the center of the video data. The nearer the distance to the piece of text information, the higher the score set for the degree of priority by the priority setting unit 135 on the basis of “distance”. Furthermore, the larger the size of the piece of text, the higher the score set for the degree of priority by the priority setting unit 135 on the basis of “text size”. As to the light emission pattern, the higher the brightness contrast between the piece of text and the surroundings, the higher the score set for the degree of priority by the priority setting unit 135 on the basis of “light emission”. Furthermore, the priority setting unit 135 determines, on the basis of “attribute”, the relevance between the piece of text information and the category of the location where the user is positioned, and the higher the relevance, the higher the score set for the degree of priority by the priority setting unit 135 for the piece of text information.

The voice output unit 136 converts pieces of text information extracted by the text extraction unit 133 into voice, and outputs the voice, in descending order of degrees of priority set by the priority setting unit 135. That is, the voice output unit 136 reads voice from the storage unit 120, the voice having been associated with the pieces of text represented by the pieces of text information extracted by the text extraction unit 133, and provides a control command to the speaker 170 to cause the speaker 170 to output the voice.

For example, in a case where the priority setting unit 135 has set the priority scores as illustrated in FIG. 4, the voice output unit 136 provides a control command to the speaker 170 to cause the speaker 170 to read aloud the pieces of text information according to the sequence indicated by “reading sequence”, from Japanese characters [symbol] [symbol] (“Central Ticket Gate Exit”), Japanese characters [symbol] [symbol] [symbol] [symbol] [symbol] (“Bound for Haneda Airport, Shinagawa, Shimbashi, and Asakusa”), Japanese characters [symbol] [symbol] [symbol] [symbol] (“Passageway to Elevator at Central Ticket Gate Exit”), Japanese characters [symbol] (“Emergency Stop Button”), Japanese characters [symbol] (“ABC Convenience Store”), and Japanese characters [symbol] (“XYZ Business Center”).

The imaging unit 140 captures video data including a video of a region around a user. The imaging unit 140, is, for example, a camera, and the camera includes optical elements and an imaging element. The optical elements are, for example, elements of an optical system, such as a lens, a mirror, a prism, and a filter. The imaging element is an element that converts light input through the optical elements into an image signal that is an electric signal. The imaging element may be, for example, a charge coupled device (CCD) sensor or a complementary metal oxide semiconductor (CMOS) sensor.

The distance measurement sensor 150 measures a distance to an object, such as a structure around a user. The distance measurement sensor 150 may be a laser distance sensor and may be implemented by, for example, light detection and ranging (LiDAR). LiDAR implements measurement of a distance to an object by irradiating the object with near-infrared light, visible light, or ultraviolet light and capturing reflected light from the object by means of an optical sensor. Furthermore, the distance measurement sensor 150 may measure a distance to an object for each position on an image by using the time of flight (ToF) method. In this case, the distance measurement sensor 150 includes a floodlighting element and a light receiving element, and measures a distance to an object by measuring the time from contact between the object and a photon emitted from the floodlighting element to reception, at the light receiving element, of reflected light reflected by the object.

The positional information sensor 160 measures positional information on the text-to-speech device 100. The positional information sensor 160 may be, for example, a global positioning system (GPS) sensor. The GPS sensor includes a receiver that receives radio waves transmitted from a GPS satellite. The GPS sensor measures the present position of the text-to-speech device 100 (for example, the latitude and longitude), that is, the present position of the user, by receiving radio waves transmitted from a plurality of GPS satellites, using differences between the times of receipt of the radio waves and the times of transmission of the radio waves by the GPS satellites, and thereby calculating the distances from the GPS satellites to the text-to-speech device 100.

The speaker 170 outputs voice according to a control command from the voice output unit 136. That is, on the basis of the control command from the voice output unit 136, the speaker 170 outputs voice to read aloud pieces of text information in descending order of their degrees of priority set by the priority setting unit 135. The speaker 170 converts an electric signal into sound by means of a diaphragm. That is, on the basis of the control command provided by means of the electric signal from the voice output unit 136, the speaker 170 vibrates the diaphragm at a predetermined amplitude and a predetermined frequency to thereby vibrate the air in contact with the diaphragm and output sound.

### Flow of First Process by Text-to-Speech Device 100

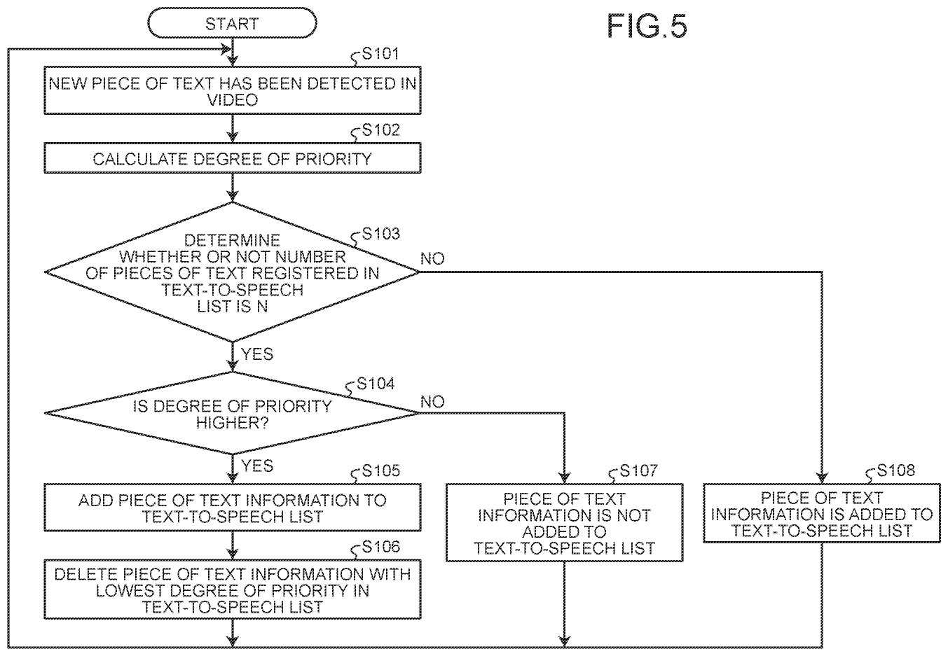

A first process performed by the text-to-speech device 100 according to the present disclosure will be described next by use of FIG. 5. FIG. 5 is a flowchart illustrating a flow of a process upon detection of a new piece of text information in the text-to-speech device according to the present disclosure. The first process by the text-to-speech device 100 according to the present disclosure will now be described in line with the flowchart illustrated in FIG. 5.

Firstly, it is assumed that the text extraction unit 133 has extracted a new piece of text information (Step S101). In this case, the priority setting unit 135 assigns a degree of priority to the new piece of text information extracted (Step S102). The priority setting unit 135 determines whether or not the number of pieces of text registered in a text-to-speech list is N (Step S103). This N is the maximum number of pieces of text to be registered in the text-to-speech list and may be a fixed number or may be optionally set by a user beforehand. In a case where the number of the pieces of text is N (Step S103: Yes), the priority setting unit 135 compares the degree of priority that has been assigned to the new piece of text information with the degree of priority of an earlier extracted piece of text information having the lowest degree of priority in the text-to-speech list, the lowest degree of priority having been assigned to the earlier extracted piece of text information that was extracted before the new piece of text information, and determines whether or not the degree of priority that has been assigned to the new piece of text information is higher (Step S104). In a case where the degree of priority assigned to the new piece of text information is higher (Step S104: Yes), the new piece of text information is added to the text-to-speech list (Step S105). Subsequently, the priority setting unit 135 deletes the earlier extracted piece of text information having the lowest degree of priority in the text-to-speech list (Step S106), returns to Step S101, and repeatedly executes the processing from Step S101 onward.

In a case where the number of the pieces of text is not N (Step S103: No), the text-to-speech device 100 adds the new piece of text information to the text-to-speech list (Step S108). The text-to-speech device 100 then returns to Step S101 and repeatedly executes the processing from Step S101 onward.

In a case where the degree of priority assigned to the new piece of text information is not higher (Step S104: No), the text-to-speech device 100 does not add the new piece of text information to the text-to-speech list (Step S107). The text-to-speech device 100 then returns to Step S101 and repeatedly executes the processing from Step S101 onward.

Even in a case where a new piece of text information has been extracted, the text-to-speech device 100 is thus able to read aloud the extracted new piece of text information in an appropriate sequence by setting a degree of priority for the new piece of text information. Therefore, the text-to-speech device 100 capable of reading aloud pieces of text from an image in an appropriate sequence is able to be provided.

### Flow of Second Process by Text-to-Speech Device 100

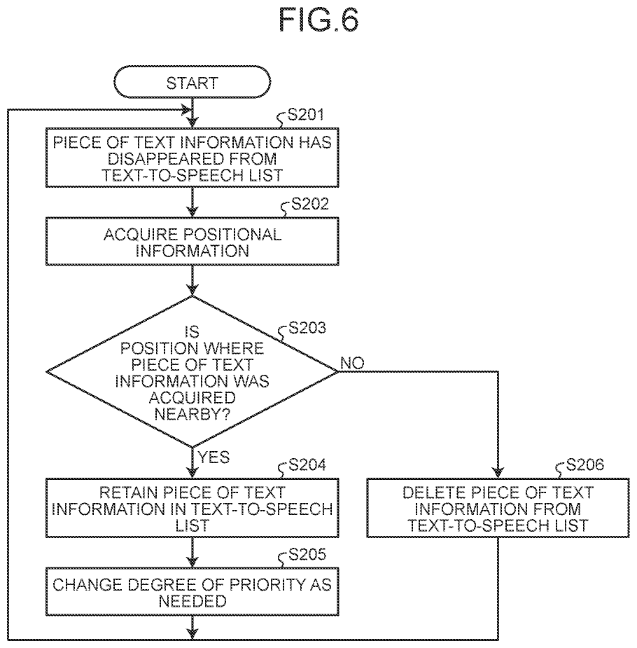

A second process performed by the text-to-speech device 100 according to the present disclosure will be described next by use of FIG. 6. FIG. 6 is a flowchart illustrating a flow of a process upon disappearance of a piece of text information from video data, at the text-to-speech device according to the present disclosure. The second process by the text-to-speech device 100 according to the present disclosure will now be described in line with the flowchart illustrated in FIG. 6.

Firstly, it is assumed that a piece of text information that has been extracted earlier from video data acquired by the text-to-speech device 100 has disappeared (Step S201). Subsequently, the text-to-speech device 100 acquires positional information (Step S202). Subsequently, the text-to-speech device 100 compares the positional information acquired and positional information at the time of extraction of that piece of text information with each other and determines whether or not the position at the time of the extraction of the piece of text information is nearby (Step S203). Whether or not the position at the time of the extraction of the piece of text information is nearby may be based on, for example, whether or not a distance between the position at the time of the extraction of the piece of text information extracted earlier and the position at the time of disappearance of the piece of text information is in a predetermined range. In a case where the position at the time of the extraction of the piece of text information is nearby (Step S203: Yes), the text-to-speech device 100 retains the piece of text information extracted earlier in the text-to-speech list (Step S204). Subsequently, the priority setting unit 135 changes the degree of priority for the piece of text information extracted earlier, as needed (Step S205). The text-to-speech device 100 then returns to Step S201 and repeatedly executes the processing from Step S201 onward.

In a case where the position at the time of the extraction of the piece of text information is not nearby (Step S203: No), the priority setting unit 135 deletes the piece of text information extracted earlier, from the text-to-speech list (Step S206). The text-to-speech device 100 then returns to Step S201 and repeatedly executes the processing from Step S201 onward.

In a case where a piece of text information extracted earlier has disappeared from video data, the text-to-speech device 100 is thus able to read aloud pieces of text information by appropriately setting a sequence according to the position where the piece of text information extracted earlier disappeared. Therefore, the text-to-speech device 100 capable of reading aloud pieces of text from an image in an appropriate sequence is able to be provided.

### Configuration and Effects

The text-to-speech device 100 according to the present disclosure includes the video data acquisition unit 131 that acquires video data including a video of a region around a user, the positional information acquisition unit 132 that acquires positional information indicating a position of the user, the category identification unit 134 that identifies, on the basis of the positional information acquired by the positional information acquisition unit 132 and map information related to an area including the position of the user indicated by the positional information, a category of a location where the user is positioned, the text extraction unit 133 that extracts, on the basis of the video data acquired by the video data acquisition unit 131, pieces of text information representing pieces of text included in the video data, the priority setting unit 135 that sets degrees of priority for the pieces of text information extracted by the text extraction unit 133, and the voice output unit 136 that converts the pieces of text information extracted by the text extraction unit 133 into voice, and outputs the voice, in descending order of the degrees of priority set by the priority setting unit 135, and the higher the relevance of the pieces of text information to the category of the location identified by the category identification unit 134, the higher the degrees of priority set by the priority setting unit 135 for the pieces of text information.

This configuration enables pieces of text information to be read aloud in descending order of relevance to a category of a location where a user is positioned, by setting a higher degree of priority to a piece of text information having higher relevance to the category. Therefore, the text-to-speech device 100 capable of reading aloud pieces of text from an image in an appropriate sequence is able to be provided.

The priority setting unit 135 in the text-to-speech device 100 according to the present disclosure sets a degree of priority for a piece of text information extracted by the text extraction unit 133, on that basis of at least one of its position in video data, its size in the video data, and a degree of contrast to the background in the video data.

This configuration enables the degree of priority to be set on the basis of at least one of the position of the extracted piece of text in the video data, its size in the video data, and the degree of contrast between the extracted piece of text and the background in the video data. Therefore, the text-to-speech device 100 capable of reading aloud pieces of text from an image in an appropriate sequence is able to be provided.

The priority setting unit 135 in the text-to-speech device 100 according to the present disclosure sets a degree of priority for a piece of text information extracted, on the basis of degrees of priority for respective pieces of text, the degrees of priority having been set for each user beforehand.

This configuration enables a degree of priority to be set for a piece of text information extracted by the text extraction unit 133 on the basis of the degrees of priority for the respective pieces of text, the degrees of priority having been set for each user beforehand. Therefore, the text-to-speech device 100 capable of reading aloud pieces of text from an image in an appropriate sequence is able to be provided.

A method of controlling the text-to-speech device according to the present disclosure includes a step of acquiring video data including a video of a region around a user, a step of acquiring positional information indicating a position of the user, a step of identifying a category of a location where the user is positioned, on the basis of the positional information acquired and map information related to an area including the position indicated by the positional information, a step of extracting, on the basis of the video data acquired, pieces of text information representing pieces of text included in the video data, a step of setting degrees of priority for the pieces of text information extracted, and a step of converting the extracted pieces of text information into voice and outputting the voice, in descending order of the degrees of priority set, and in the step of setting the degrees of priority, the higher the relevance of the pieces of text information to the category of the location identified, the higher the degrees of priority set for the pieces of text information.

This configuration enables pieces of text information to be read aloud in descending order of relevance to a category of a location where a user is positioned, by setting a higher degree of priority to a piece of text information having higher relevance to the category. Therefore, a method of controlling the text-to-speech device capable of reading aloud pieces of text from an image in an appropriate sequence is able to be provided.

A program according to the present disclosure includes a step of acquiring video data including a video of a region around a user, a step of acquiring positional information indicating a position of the user, a step of identifying a category of a location where the user is positioned, on the basis of the positional information acquired and map information related to an area including the position indicated by the positional information, a step of extracting, on the basis of the video data acquired, pieces of text information representing pieces of text included in the video data, a step of setting degrees of priority for the pieces of text information extracted, and a step of converting the extracted pieces of text information into voice and outputting the voice, in descending order of the degrees of priority set, and in the step of setting the degrees of priority, the higher the relevance of the pieces of text information to the category of the location identified, the higher the degrees of priority set for the pieces of text information.

The above-described program may be provided by being stored in a non-transitory computer-readable storage medium, or may be provided via a network such as the Internet. Examples of the computer-readable storage medium include optical discs such as a digital versatile disc (DVD) and a compact disc (CD), and other types of storage devices such as a hard disk and a semiconductor memory.

This configuration enables pieces of text information to be read aloud in descending order of relevance to a category of a location where a user is positioned, by setting a higher degree of priority to a piece of text information having higher relevance to the category. Therefore, a program that enables pieces of text in an image to be read aloud in an appropriate sequence is able to be provided.

According to the present disclosure, a text-to-speech device, a method of controlling the text-to-speech device, and a computer-readable storage medium that enable pieces of text from an image to be read aloud in an appropriate sequence are able to be implemented.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. A text-to-speech device, comprising:
a video data acquisition unit configured to acquire video data including a video of a region around a user;
a positional information acquisition unit configured to acquire positional information indicating a position of the user;
a category identification unit configured to identify a category of a location where the user is positioned, based on the positional information acquired by the positional information acquisition unit and map information related to an area including the position of the user indicated by the positional information;
a text extraction unit configured to extract pieces of text information representing pieces of text included in the video data, based on the video data acquired by the video data acquisition unit;
a priority setting unit configured to set degrees of priority for the pieces of text information extracted by the text extraction unit; and
a voice output unit configured to convert the pieces of text information extracted by the text extraction unit into voice, and outputs the voice, in descending order of the degrees of priority set by the priority setting unit, wherein
the higher relevance of the pieces of text information to the category of the location identified by the category identification unit, the higher the degrees of priority set by the priority setting unit for the pieces of text information.

2. The text-to-speech device according to claim 1, wherein the priority setting unit is configured to set the degrees of priority for the pieces of text information extracted by the text extraction unit, based on at least one of positions of the pieces of text information in the video data, sizes of the pieces of text information in the video data, and degrees of contrast between the pieces of text information and a background in the video data.

3. The text-to-speech device according to claim 1, wherein the priority setting unit is configured to set the degrees of priority for the pieces of text information extracted by the text extraction unit, based on preset degrees of priority for respective pieces of text that have been set per user beforehand.

4. A method of controlling a text-to-speech device, comprising:
acquiring video data including a video of a region around a user;
acquiring positional information indicating a position of the user;
identifying a category of a location where the user is positioned, based on the positional information acquired and map information related to an area including the position indicated by the positional information;
extracting pieces of text information representing pieces of text included in the video data, based on the acquired video data;
setting degrees or priority for the extracted pieces of text information; and
converting the extracted pieces of text information into voice and outputting the voice, in descending order of the set degrees of priority, wherein
the higher relevance of the pieces of text information to the identified category of the location, the higher the set degrees of priority at the setting the degrees of priority.

5. A non-transitory computer-readable storage medium storing a program causing a computer to execute:
acquiring video data including a video of a region around a user;
acquiring positional information indicating a position of the user;
identifying a category of a location where the user is positioned, based on the positional information acquired and map information related to an area including the position indicated by the positional information;
extracting pieces of text information representing pieces of text included in the video data, based on the acquired video data;
setting degrees or priority for the extracted pieces of text information; and
converting the extracted pieces of text information into voice and outputting the voice, in descending order of the set degrees of priority, wherein
the higher relevance of the pieces of text information to the identified category of the location, the higher the set degrees of priority at the setting the degrees of priority.
